(19) United States
(12) Patent Application Publication
(10) Pub. No.: US 2024/0279370 A1
(43) Pub. Date: Aug. 22, 2024

(54) RUBBER COMPOSITION COMPRISING A HIGHLY SATURATED DIENE ELASTOMER

(71) Applicant: COMPAGNIE GENERALE DES ETABLISSEMENTS MICHELIN, Clermont-Ferrand (FR)

(72) Inventors: JOSE-CARLOS ARAUJO DA SILVA, Clermont-Ferrand (FR); BENJAMIN GORNARD, Clermont-Ferrand (FR); FRANCOIS LALLET, Clermont-Ferrand (FR)

(21) Appl. No.: 18/268,793

(22) PCT Filed: Nov. 29, 2021
(86) PCT No.: PCT/FR2021/052123

§ 371 Date: Jun. 21, 2023

(30) Foreign Application Priority Data
Dec. 23, 2020 (FR) FR2014020

(51) Int. Cl. C08F 210/02; B60C 1/00; C08K 3/04; C08K 5/098

(52) U.S. Cl. CPC C08F 210/02; B60C 1/0041; C08K 3/04; C08K 5/098

(57) ABSTRACT

A rubber composition is based on at least an elastomer matrix predominantly comprising a highly saturated diene elastomer, carbon black and a tall oil ester plasticizer, the highly saturated diene elastomer being a copolymer of ethylene and a 1,3-diene in which the ethylene units represent at least 50 mol % of the monomer units of the copolymer.

The field of the present invention is that of rubber compositions based on highly saturated diene elastomer, which are intended to be used in a tyre, notably in its tread.

The use of highly saturated diene elastomer is known in the prior art. For example, copolymers of ethylene and 1,3-butadiene and their application in a tyre tread is described in WO 2014/114607 A1. It is stated in said document that the use of these copolymers results in good wear resistance and rolling resistance properties of the tyre.

In parallel, the use of tall oil ester plasticizer is described in documents JP2008201933, JP2008201944 and JP2008201945 in various elastomer matrices which do not comprise a highly saturated diene elastomer, with effects which are also varied and depend on the elastomer matrices in which this type of plasticizer is used.

In the field discussed above of tyres comprising a highly saturated diene elastomer in the tread, there is still a need for rubber compositions with an improved balance between the glass transition temperature properties of the mixture, which is important for optimizing the tyre's grip on the ground, and the stiffness.

It is known to those skilled in the art that the grip of the tyre is adjusted according to the temperature of use by means of the glass transition temperature of the mixture. In particular, in cold weather, a person skilled in the art must reduce the glass transition temperature of the mixture relative to the glass transition temperature of the mixture used in hot weather. In order to decrease the glass transition of the mixture, a person skilled in the art may add an oil with a low glass transition temperature to the composition. However, the use of an oil causes dilution of the polymers and results in a decrease in the stiffness of the mixture. Lowering the stiffness of the mixture adversely affects the behaviour of the tyre and increases tread wear. The problem to be solved by a person skilled in the art is that of being able to reduce the glass transition of the mixture without excessively reducing the stiffness of said mixture.

The Applicant has found a rubber composition which makes it possible to meet this need in the field of application of highly saturated diene elastomers for tyres and in particular for the tread.

Thus, a first subject of the invention is a rubber composition based on at least an elastomer matrix predominantly comprising a highly saturated diene elastomer, carbon black and a tall oil ester plasticizer; the highly saturated diene elastomer being a copolymer of ethylene and a 1,3-diene in which the ethylene units represent at least 50 mol % of the monomer units of the copolymer.

Another subject of the invention is a pneumatic or non-pneumatic tyre casing which comprises a rubber composition in accordance with the invention, preferably in the tread.

### I—DEFINITIONS

The expression “composition based on” should be understood as meaning a composition comprising the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is the one representing the greatest mass among the fillers of the composition. By way of example, in a system comprising only one elastomer, the latter is predominant for the purposes of the present invention, and in a system comprising two elastomers, the predominant elastomer represents more than half of the mass of the elastomers. In contrast, a “minor” compound is a compound which does not represent the greatest fraction by mass among the compounds of the same type. Preferably, the term “predominant” means present to more than 50%, preferably more than 60%, 70%, 80%, 90%, and more preferentially the “predominant” compound represents 100%.

The compounds mentioned in the description may be of fossil origin or may be biobased. In the latter case, they may be partially or completely derived from biomass or may be obtained from renewable starting materials derived from biomass. Similarly, the compounds mentioned may also be derived from the recycling of already-used materials, i.e. they may be partly or totally derived from a recycling process, or obtained from raw materials which are themselves derived from a recycling process. Polymers, plasticizers, fillers, etc. are notably concerned.

Unless otherwise indicated, as in the examples below, the values for glass transition temperature “Tg” described in the present document are measured in a known manner by DSC (Differential Scanning calorimetry) according to the standard ASTM D3418 (1999).

### II—DESCRIPTION OF THE INVENTION

### II-1 Elastomer Matrix

The term “elastomer matrix” means all the elastomers of the composition.

According to the invention, the elastomer matrix predominantly comprises at least one highly saturated diene elastomer, namely a copolymer containing ethylene units and diene units (referred to hereinbelow as “the copolymer”).

The highly saturated diene elastomer that is useful for the purposes of the invention is a copolymer, preferably a random copolymer, which comprises ethylene units resulting from the polymerization of ethylene. In a known manner, the term “ethylene unit” refers to the —(CH2-CH2)- unit resulting from the insertion of ethylene into the elastomer chain. The highly saturated diene elastomer is rich in ethylene units, since the ethylene units represent at least 50 mol % of all of the monomer units of the elastomer.

Preferably, the highly saturated diene elastomer comprises at least 65 mol % of ethylene units. In other words, the ethylene units preferentially represent at least 65 mol % of all of the monomer units of the highly saturated diene elastomer. More preferentially, the highly saturated diene elastomer comprises from 65 mol % to 90 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the expression “1,3-diene unit” refers to the units resulting from the insertion of 1,3-diene via a 1,4 addition, a 1,2 addition or a 3,4 addition in the case of isoprene. The 1,3-diene units are those, for example, of a 1,3-diene containing 4 to 12 carbon atoms, such as 1,3-butadiene, isoprene, 1,3-pentadiene or an aryl-1,3-butadiene. Preferably, the 1,3-diene is 1,3-butadiene, in which case the highly saturated diene elastomer is a copolymer of ethylene and of 1,3-butadiene, which is preferably statistical.

The highly saturated diene elastomer that is useful for the purposes of the invention may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the Applicant. The highly saturated diene elastomer, including the case when it is random, may also be prepared via a process using a catalytic system of preformed type such as those described in WO 2017/093654 A1, WO 2018/020122 A1 and WO 2018/020123 A1.

The highly saturated diene elastomer in the composition of the invention preferably contains units of formula (I) [Chem 1] or units of formula (II) [Chem 2].

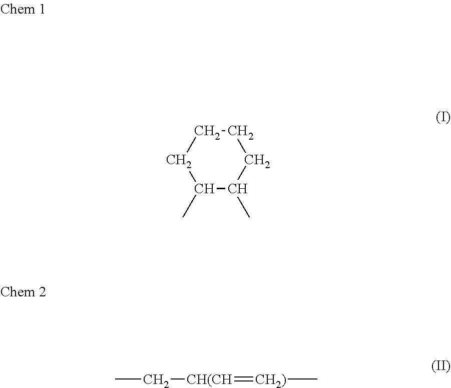

The presence of a saturated 6-membered ring unit, 1,2-cyclohexanediyl, of formula (I) in the copolymer may result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1) Math 1, more preferentially the equation (eq. 2) Math 2, and more preferentially the equation (eq. 3) Math 3, o and p being calculated on the basis of all of the monomer units of the highly saturated diene elastomer.

$$\begin{matrix}Math 1 & \\ 0 < o + p \leq 35 & ( eq . 1 )\end{matrix}$$

$$\begin{matrix}Math 2 & \\ 0 < o + p \leq 25 & ( eq . 2 )\end{matrix}$$

$$\begin{matrix}Math 3 & \\ 0 < o + p < 20 & ( eq . 3 )\end{matrix}$$

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is at least 50 parts by weight per hundred parts of elastomer of the rubber composition (phr). Preferably, the content of the highly saturated diene elastomer in the rubber composition varies in a range extending from 80 to 100 phr. More preferentially, it varies in a range extending from 90 to 100 phr.

In addition, the elastomer matrix of the composition of the invention may comprise any type of elastomer, in minor amount. The diene elastomers known to those skilled in the art for their use in the field of tyres are noted in particular.

### II-2 Specific Plasticizer

According to the invention, the rubber composition is based on at least one tall oil ester plasticizer (also known as “tallate”).

Preferably, for the purposes of the invention, the tall oil ester plasticizer is present in the composition in a content ranging from 5 to 50 phr, preferably from 7 to 40 phr and more preferentially from 8 to 30 phr. Very preferentially, the content of the tall oil ester plasticizer is in the range from 8 to 15 phr.

Preferably, the tall oil ester plasticizer is a compound of formula TI(OR)3 in which R is a linear or branched alkyl and TI represents tall oil (or tallate).

Preferably, R is an alkyl comprising from 4 to 20 carbon atoms, preferably from 6 to 12 carbon atoms and more preferentially from 6 to 10 carbon atoms.

Preferably, R is a branched alkyl, and very preferentially, R is an isooctyl radical.

Very preferentially, the tall oil ester plasticizer is the compound isooctyl tallate, [Chem 3] below.

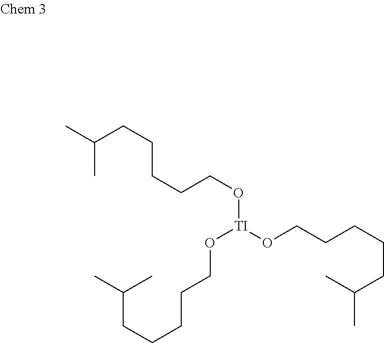

Isooctyl tallate, CAS number 68333-78-8, has a glass transition temperature of −110° C. and is sold, for example, under the name Plasthall 100 by the company Hallstar.

In addition, the composition according to the invention advantageously does not comprise any plasticizer other than the specific plasticizer above, or contains less than 15 phr thereof, preferably less than 10 phr thereof, preferably less than 5 phr thereof.

### II-3 Reinforcing Filler

The rubber composition in accordance with the invention also has the essential characteristic of comprising a reinforcing filler comprising carbon black.

A reinforcing filler typically consists of nanoparticles whose mean (mass-average) size is less than a micrometre, generally less than 500 nm, usually between 20 and 200 nm, in particular and more preferentially between 20 and 150 nm.

Any carbon black, notably the blacks conventionally used in tyres or their treads (known as tyre-grade blacks), is suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. When the rubber composition in accordance with the invention is used in a tread, the carbon black is preferentially a carbon black of the 100 or 200 series.

The content of carbon black may vary within a wide range and is adjusted by a person skilled in the art according to the envisaged use of the rubber composition, in particular in the tyre sector. For use of the rubber composition in a tread, in particular for vehicles intended to carry heavy loads, the content of carbon black in the rubber composition is preferentially between 15 and 65 phr. For such a use in the heavy goods vehicle sector, the rubber composition may have an insufficient level of reinforcement below 15 phr and may show excessive hysteresis above 65 phr. Preferably, the carbon black content in the rubber composition is within a range from 20 to 45 phr.

### II-4 Crosslinking System

The crosslinking system may be any type of system known to those skilled in the art in the field of rubber compositions for tyres. It may notably be based on sulfur, and/or peroxide and/or bismaleimides.

Preferentially, the crosslinking system is based on sulfur; it is then called a vulcanization system. The sulfur may be provided in any form, notably in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used in a preferential content of between 0.2 phr and 10 phr, more preferentially between 0.3 and 5 phr. The vulcanization accelerator or mixture of accelerators is used in a preferential content of between 0.5 and 10 phr, more preferentially between 0.5 and 5 phr.

Use may be made, as accelerator, of any compound that is capable of acting as an accelerator for the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate type. As examples of such accelerators, mention may notably be made of the following compounds: 2-mercaptobenzothiazyl disulfide (abbreviated as “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and mixtures of these compounds.

### II-5 Possible Additives

The rubber compositions according to the invention may optionally also include all or some of the usual additives customarily used in elastomer compositions for tyres, for instance plasticizers (such as plasticizing oils and/or plasticizing resins), pigments, protective agents such as anti-ozone waxes, chemical anti-ozonants, antioxidants, anti-fatigue agents, reinforcing resins (as described, for example, in patent application WO 02/10269).

However, in a particularly advantageous manner, the composition according to the invention does not comprise any plasticizer other than those mentioned above, or comprises less than 20 phr thereof, preferably less than 10 phr thereof, preferably less than 5 phr thereof.

Advantageously, the composition according to the invention does not comprise any plasticizing hydrocarbon resin.

### II-6 Preparation of the Rubber Compositions

The compositions in accordance with the invention may be manufactured in appropriate mixers using two successive preparation phases that are well known to those skilled in the art:
a first phase of thermomechanical working or kneading (“non-productive” phase), that can be performed in a single thermomechanical step during which all the necessary constituents, notably the elastomeric matrix, the reinforcing filler and the various other optional additives, with the exception of the crosslinking system, are introduced into an appropriate mixer, such as a standard internal mixer (for example of Banbury type). The incorporation of the optional filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the optional various other additives, with the exception of the crosslinking system, are incorporated. The non-productive phase may be performed at high temperature, up to a maximum temperature of between 110° C. and 200° C., preferably between 130° C. and 185° ° C., for a period of time generally of between 2 and 10 minutes;
a second phase of mechanical working (“productive” phase), which is performed in an external mixer, such as an open mill, after cooling the mixture obtained during the first non-productive phase down to a lower temperature, typically below 120° C., for example between 40° C. and 100° C. The crosslinking system is then incorporated and the combined mixture is then mixed for a few minutes, for example between 5 and 15 min.

Such phases have been described, for example, in patent applications EP-A-0501227, EP-A-0735088, EP-A-0810258, WO 00/05300 or WO 00/05301.

The final composition thus obtained is then calendered, for example in the form of a sheet or of a slab, notably for laboratory characterization, or else is extruded (or co-extruded with another rubber composition) in the form of a rubber semi-finished product (or profiled element) which can be used, for example, as a tyre tread. These products may then be used for the manufacture of tyres, according to the techniques known to those skilled in the art.

The composition may be either in the green state (before crosslinking or vulcanization) or in the cured state (after crosslinking or vulcanization), and may be a semi-finished product which can be used in a tyre.

The crosslinking (or curing), or, where appropriate, the vulcanization, is performed in a known manner at a temperature generally between 130° C. and 200° C., for a sufficient time which may range, for example, between 5 and 90 min, notably depending on the curing temperature, the crosslinking system adopted and the crosslinking kinetics of the composition under consideration.

### II-7 Tyre

A subject of the present invention is also a tyre comprising a rubber composition according to the invention.

Preferably, the composition according to the invention is present at least in the tread of the tyre according to the invention.

The tyre according to the invention may be intended to equip motor vehicles of passenger vehicle type, SUVs (sport utility vehicles), or two-wheel vehicles (notably motorcycles), or aircraft, or else industrial vehicles chosen from vans, heavy-duty vehicles, i.e. underground trains, buses, heavy road transport vehicles (lorries, tractors, trailers) or off-road vehicles, such as heavy agricultural vehicles or construction vehicles, and the like.

The abovementioned features of the present invention, and also others, will be understood more clearly on reading the following description of several implementation examples of the invention, which are given as nonlimiting illustrations.

### III. EXAMPLES OF IMPLEMENTATION OF THE INVENTION

### III.1 Tests and Measurements:

### III.1-1 Determination of the Microstructure of the Elastomers:

The microstructure of the elastomers is determined by 1H NMR analysis, combined with 13C NMR analysis when the resolution of the 1H NMR spectra does not make it possible to assign and quantify all the entities. The measurements are performed using a Bruker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analysed material and a deuterated solvent enabling swelling, generally deuterated chloroform (CDCl₃). The solvent used must always be deuterated and its chemical nature may be adapted by a person skilled in the art. The amounts of material used are adjusted so as to obtain spectra of sufficient sensitivity and resolution.

The soluble samples are dissolved in a deuterated solvent (about 25 mg of elastomer in 1 ml), generally deuterated chloroform (CDCl₃). The solvent or solvent blend used must always be deuterated and its chemical nature may be adapted by a person skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

### III.1-2 Measurement of the Dynamic Properties:

### Dynamic Properties

The dynamic properties are measured on a viscosity analyser (Metravib V A4000) according to the standard ASTM D5992-96. The response of a sample of vulcanized composition (cylindrical test specimen with a thickness of 4 mm and a cross section of 400 mm²), subjected to a simple alternating sinusoidal shear stress, at a frequency of 10 Hz, according to the standard ASTM D 1349-99, is recorded.

The following results are based on measurements using temperature scans at a given stress and strain scans at a stress frequency of 10 Hz.

Stiffness: the stiffness is determined at a strain of 50% return during a strain scan at 60° C. from 0.1% to 100% peak-to-peak strain.

Glass transition temperature: the glass transition is determined as the temperature at which the mixture has a maximum G″ value in imposed stress shear tests of 0.7 MPa.

### III.2 Preparation of the Rubber Compositions:

The rubber compositions, the details of the formulation of which are given in Table 1, were prepared in the following manner:

The elastomer, the reinforcing filler and also the various other ingredients, with the exception of sulfur and vulcanization accelerators, are successively introduced into an internal mixer (final filling rate: approximately 70% by volume), whose initial tank temperature is approximately 90° C. The oils are introduced at 115° C. Thermomechanical working (non-productive phase) is then performed in one step, lasting a total of about 3 to 4 minutes, until a maximum “drop” temperature of 160° C. is reached. The mixture thus obtained is recovered, cooled and the sulfur and vulcanization accelerators are then incorporated on a mixer (homo-finisher) at 30° ° C., the whole being mixed (productive phase) for an appropriate time (for example about 10 minutes).

The compositions thus obtained are subsequently calendered, either in the form of slabs (thickness of 2 to 3 mm) or of thin sheets of rubber, for measurement of their physical or mechanical properties, or extruded in the form of a tyre tread.

The elastomer (EBR) is prepared according to the following procedure:

30 mg of metallocene [{Me2SiFlu2Nd(μ-BH4)2Li(THF)}2, the symbol Flu representing the fluorenyl group of formula C13H8], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at ambient temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven. In a reactor containing, at 80° C., methylcyclohexane, ethylene and butadiene in proportions of 80/20 mol % ethylene/butadiene, butyloctylmagnesium (BOMAG) is added to neutralize the impurities in the reactor, then the catalytic system is added. At this time, the reaction temperature is regulated at 80° C. and the polymerization reaction starts. The polymerization reaction takes place at a constant pressure of 8 bar. The reactor is fed throughout the polymerization with ethylene and butadiene in proportions of 80/20 mol % (ethylene/butadiene). The polymerization reaction is stopped by cooling, degassing of the reactor and addition of ethanol. An antioxidant is added to the polymer solution. The copolymer is recovered by drying in an oven under vacuum to constant mass.

The catalytic system is a preformed catalytic system. It is prepared in methylcyclohexane from a metallocene, [Me2Si(Flu)2Nd(μ-BH4)2Li(THF)], a co-catalyst, butyloctylmagnesium (BOMAG), and a preformation monomer, 1,3-butadiene, in the following contents: metallocene: 0.00007 mol/L, co-catalyst: 0.00036 mol/L. It is prepared according to a preparation method in accordance with paragraph II.1 of patent application WO 2017/093654 A1.

Rubber composition C3 is in accordance with the invention. The rubber compositions C1 and C2 are not in accordance with the invention because they do not comprise the specific plasticizing system required in the invention.

TABLE 1

| Components | C1 | C2 | C3 |
|---|---|---|---|
| EBR (1) | 100 | 100 | 100 |
| Carbon black (2) | 42 | 42 | 42 |
| Oil 1 (3) | — | 11 | — |
| Oil 2 (4) | — | — | 11 |
| Wax (5) | 1 | 1 | 1 |
| Antioxidant (6) | 2 | 2 | 2 |
| Stearic acid | 1.5 | 1.5 | 1.5 |
| ZnO | 2.5 | 2.5 | 2.5 |
| Diphenylguanidine | 0.5 | 0.5 | 0.5 |
| Accelerators (7) | 0.8 | 0.8 | 0.8 |
| Sulfur | 0.4 | 0.4 | 0.4 |

(1) EBR Mooney 85, ethylene content: 77%,
(2) Carbon black, ASTM N234 from the company Cabot,
(3) “Extensoil 51” liquid paraffin from the company Repsol,
(4) “Plasthall 100” oil from the company Hallstar,
(5) Ozone wax C32 ST,
(6) Santoflex 6PPD from the company Flexsys,
(7) Accelerators: cyclohexylbenzothiazylsulfenamide CBS and tetrabenzylthiuram disulfide TBzTD from the company Akrochem.

### III.3 Results:

The results are given in Table 2.

TABLE 2

| MDC measurements | C1 | C2 | C3 |
|---|---|---|---|
| Stiffness at 60° C. (G* 50% | 1.25 | 0.92 | 1.07 |
| return) | | | |
| Glass transition (T G″ max) | −39.45 | −43.47 | −47.08 |

The results show that the composition in accordance with the invention makes it possible to simultaneously lower the glass transition of the mixture, while maintaining high levels of stiffness, suitable for use in tyre treads. Lowering of the glass transition temperature of the mixture allows this formulation to be used at lower temperatures and the lower reduction in stiffness makes it possible to maintain good tyre performance and also acceptable wear of the composition in the tread.

1.-13. (canceled)

14. A rubber composition based on at least an elastomer matrix predominantly comprising a highly saturated diene elastomer, carbon black and a tall oil ester plasticizer, the highly saturated diene elastomer being a copolymer of ethylene and a 1,3-diene in which the ethylene units represent at least 50 mol % of the monomer units of the copolymer.

15. The rubber composition according to claim 14, wherein the ethylene units represent between 50 mol % and 95 mol % of the monomer units of the copolymer.

16. The rubber composition according to claim 14, wherein the ethylene units represent at least 65 mol % of the monomer units of the copolymer.

17. The rubber composition according to claim 14, wherein the 1,3-diene is 1,3-butadiene.

18. The rubber composition according to claim 14, wherein the copolymer is a random copolymer.

19. The rubber composition according to claim 14, wherein a content of highly saturated diene elastomer in the rubber composition varies within a range from 80 to 100 phr.

20. The rubber composition according to claim 14, wherein a content of tall oil ester plasticizer is within a range from 5 to 50 phr.

21. The rubber composition according to claim 14, wherein the tall oil ester plasticizer is an aliphatic tall oil ester plasticizer and is a compound of formula TI(OR)3 in which R is a linear or branched alkyl and Tl represents tall oil.

22. The rubber composition according to claim 21, wherein R is an alkyl comprising from 4 to 20 carbon atoms.

23. The rubber composition according to claim 21, wherein R is a branched alkyl.

24. The rubber composition according to claim 14, wherein the tall oil ester plasticizer is the compound isooctyl tallate.

25. The rubber composition according to claim 14, wherein a carbon black content is between 15 and 65 phr.

26. A pneumatic or non-pneumatic tire casing which comprises the rubber composition according to claim 14.
